(19) United States
(12) Patent Application Publication
(10) Pub. No.: US 2025/0222386 A1
(43) Pub. Date: Jul. 10, 2025

(54) FILTER SILENCER

(71) Applicant: PSI Global Ltd., Stockton-on-tees (GB)

(72) Inventors: Daniel Stuart Hunter, Newton Aycliffe Durham (GB); Ian Mark Davis, Stockton-on-Tees (GB); Jolyon Bugg, Nathallerton (GB); Jon Sherwood Hunter, Ferryhill (GB); Lloyd Cochrane, Durham (GB)

(21) Appl. No.: 18/879,467

(22) PCT Filed: Jun. 28, 2023
(86) PCT No.: PCT/GB2023/051682

§ 371 Date: Dec. 27, 2024

(30) Foreign Application Priority Data
Jun. 29, 2022 (GB) 2209575.6

(51) Int. Cl. B01D 46/24; B01D 39/16; B01D 39/20; B01D 46/00

(52) U.S. Cl. CPC B01D 46/2414; B01D 39/1623; B01D 39/2024; B01D 46/0005; B01D 46/0031; B01D 2239/0478; B01D 2265/022

(57) ABSTRACT

A filter silencer is provided having a cartridge (12) formed with circumferentially directed outwardly projecting lugs (18) at its upper rim configured for forming a bayonet fit into slots (42) at a top rim (36) of a receiving cage (28) forming part of a housing for the filter. The housing may further comprise a bowl (46) having an upper rim formed with projecting lugs (48) configured for forming a bayonet fit into slots (44) at a bottom rim (40) of the receiving cage. If the cartridge and the bowl each have four lugs, the bowl can be fastened or removed at a quarter turn and the cartridge can also be installed into the cage or removed at a quarter turn.

### FIELD OF THE INVENTION

This invention relates to filter silencers for compressed gas streams, particularly compressed air systems, contaminated by atomised oil, and to removable cartridges for fitting into housings of such silencers.

### BACKGROUND TO THE INVENTION

GB-B-2033247 explains that it is very rare for compressed air not to return to its original ambient conditions and often in industry when compressed air exhausts to atmospheric pressure through a control valve a great deal of noise is created. Not only is noise created but any contamination within the airline is exhausted into the atmosphere. The noise levels can be above 125 decibels which is very damaging to the sense of hearing and contamination such as oil aerosol can be damaging to the respiratory system. Health and safety organisations throughout the world were implementing stringent controls covering working conditions and a particular interest was being taken in the reduction of noise and air pollution levels in industry.

For example, when pneumatic equipment is used it is generally accepted that a lubricator should be fitted to ensure that the moving parts receive lubrication. As an example, a pneumatic piston and cylinder assembly requires lubrication on the cylinder wall to stop the piston scoring the bore and to increase the life of the piston seal. In the case of an oil lubricated air compressor, a certain amount of oil is atomised and carried downstream. This means a high oil level concentration in the exhausting air. Similarly on the exhaust side of an oil lubricated vacuum pump the air needs to be filtered and silenced.

Prior to the '247 invention, when noise control had been necessary, attachments had been fixed to exhaust ports to reduce the noise level of the escaping air. However, these attachments did not reduce the contamination level and in some cases where sintered material was used, these increased this pollution by atomising lubricating oil so that it was sprayed into the atmosphere. Recently, however, filter silencers had been produced which provided a 30 to 35 decibel reduction in noise level. So far as could be ascertained, the filtration efficiency of these attachments by DOP methods was for the best 99.9% and for the worst less than 10%.

A main object of the '247 invention was to provide a filter silencer that was substantially more effective than any heretofore proposed in that it provided a DOP efficiency of at least 99.95% and generally in the order of 99.999% having an oil removal efficiency of the same order with a noise reduction that could be as great as 50 to 60 decibels. A further object was effectively to accommodate pulsating flow patterns that occurred when the air supply was switched on and off.

The '247 invention provided, so far as is relevant, a filter silencer for compressed gas streams contaminated by dirt, water, oil or atomised oil aerosol comprising a casing containing at least one vertical hollow filter element, and means for directing a gas stream to pass outwards from inside the filter element through the wall of the filter element whereby, when the filter silencer is in use, the noise level of the gas stream is reduced and solid dirt particles are trapped by the filter element while oil aerosol is coalesced and passes through the filter element as bulk oil with any water to the outside-of the filter element to drain into a bowl forming part of the casing and for further directing the gas to atmosphere wholly through a casing wall having apertures sufficiently large to pass the gas therethrough substantially at atmospheric pressure, an intervening space of a size sufficient substantially to eliminate any carryover of oil to the silencing element or elements or casing wall being provided between the filter element and the casing wall.

In the applicants' current product, the gas stream is introduced through an aperture in the top surface of the casing and passes into the filter element through an inlet tube extending downwardly through an aperture in a top cap of the filter element. The lower end of the inlet tube is threaded and the filter element has a lower end cap provided on its inner surface with a threaded bar for insertion into the inlet tube, rotation of the filter element relative to the casing engaging the threads and securing the filter element in position within the casing.

An object of the invention is to provide a more rapid and convenient arrangement for fitting the filter element into and removing the filter element from the housing.

### SUMMARY OF THE INVENTION

In one aspect the invention provides a filter silencer having a cartridge formed with circumferentially directed outwardly projecting lugs at its upper rim configured for forming a bayonet fit into slots at a top rim of a receiving cage forming part of a housing for the filter. The filter housing may further comprise a bowl having an upper rim formed with projecting lugs configured for forming a bayonet fit into slots at a bottom rim of the receiving cage. In each case, if there are four such lugs, the cartridge and the bowl may each be fastened and released by a quarter turn. Advantageously each lug of the cartridge and/or bowl has a tapered leading edge for facilitating insertion into a slot and a downwardly projecting tab at its trailing end for abutment with an adjacent region of the housing to define a fully inserted rotational position.

Advantageously the slots in the top rim of the receiving cage extend radially through the rim and open to the exterior surface thereof so that the lugs of the cartridge are visible from the exterior of the filter silencer when the cartridge has been fitted into position. Similarly, the upper end of the bowl may be formed with projecting lugs for fitting into slots in a lower rim of the depending wall. The receiving cage may be of a plastics material, for example nylon. The bowl may also be of plastics material e.g. polypropylene.

In another aspect the invention provides a housing for a cartridge of a filter silencer comprising a cage for accommodating the cartridge and a bowl removably connectable to the cartridge to permit insertion and removal of the cartridge and also to collect coalesced oil, wherein a top rim of the cage is formed with a plurality of slots for receiving protuberant lugs at the top of the cartridge and providing a removable bayonet fit between them. In an embodiment, a bottom rim of the cage is also provided with a plurality of slots to receive protuberant lugs at the top of the bowl for providing a removable bayonet fit between the cage and the bowl.

In another aspect, there is provided a cartridge for a filter silencer for a compressed air stream that may be contaminated by atomised oil aerosol,
said cartridge comprising upper and lower end caps of glass-filled nylon and a tubular coalescing filter extending between and adhered to the end caps,
the filter comprising a filter element of resin-bonded glass fibres for coalescing oil in the compressed air stream and a drainage layer for collecting coalesced oil and allowing it to flow through or past the lower end cap,
wherein a rim of the upper end cap is formed with radially outward projecting lugs that in use rotationally fit into circumferentially directed slots within a filter housing immediately below an upper end thereof for retaining the cartridge in the housing with its upper end below the upper end of the housing.

The invention further provides a filter silencer for a compressed air stream that may be contaminated by atomised oil aerosol comprising a cartridge as defined above and a housing comprising a cage into which the cartridge can be removably fitted and a bowl that can be removably attached to a lower end of the cage for collecting oil coalesced by the cartridge,
the cage a having a roof and a depending wall with an annular top rim and apertures beneath the rim for discharge of air that has passed through the cartridge, the roof being formed with a central aperture and provided with a connector for receiving the compressed air stream and passing it through the central aperture to an inlet tube on its inner face for leading the compressed air stream into the cartridge and towards its lower end, and the top rim being formed with circumferentially directed slots for slidable insertion and removal of the lugs of the end cap on rotation of the cartridge relative to the end cap.

The upper end cap of the cartridge may have a central aperture configured to receive and fit gas-tightly around an air flow tube depending from the upper end of the housing. The end caps may be of plastics material, suitably a glass-filled plastics material, for example 15% glass-filled nylon 6.

The glass fibres of the filter element may be bonded by a water-soluble acid-based resin binder comprising a carboxylated acrylic polymer and a polyfunctional alcohol. The drainage layer may be of polyester fibres coated with fluorocarbon.

### BRIEF DESCRIPTION OF THE DRAWINGS

Embodiments of the invention will now be described, by way of example, with reference to the accompanying drawings, in which:

FIG. 1 is an exploded view of a filter cartridge and a cage for removably receiving the filter cartridge;

FIG. 2 is a side view of a filter silencer showing a cartridge in position in the filter cage with a removable bowl attached at the lower end of the bowl for receiving coalesced oil;

FIG. 3 is a detailed sectional view adjacent the upper rim of the filter silencer showing a lug forming part of the filter top end cap received in a slot at the upper end of the cage;

FIG. 4 is a side view of the housing with the bowl detached beneath the filter cage;

FIG. 5 is a side view from slightly above of an embodiment of the filter silencer;

FIG. 6 is a perspective view of the filter forming part of the filter silencer if FIG. 6; and

FIG. 7 is a view of the filter silencer in vertical section.

### DETAILED DESCRIPTION OF PREFERRED EMBODIMENTS

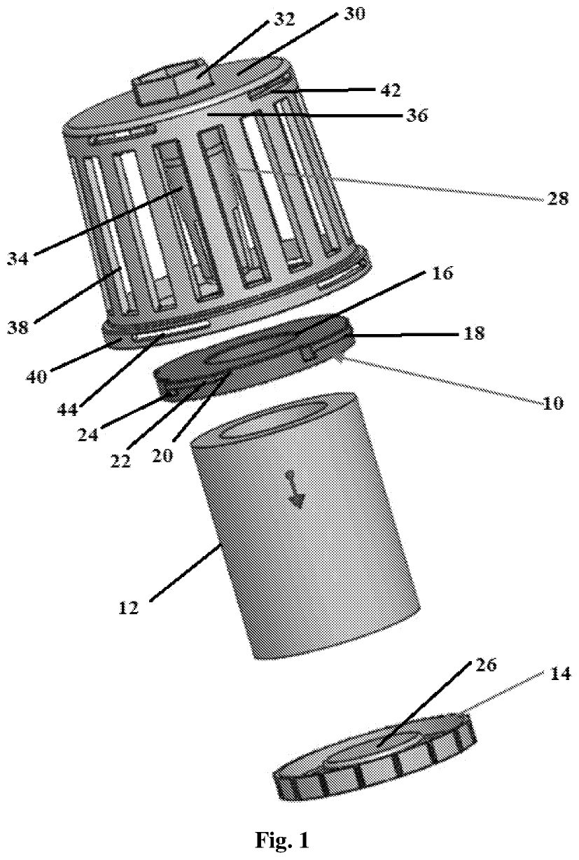

The filter silencer of the invention employs a filter cartridge as shown in FIG. 1 which comprises an upper end cap cap 10, a cylindrical filter medium 12 and a lower end cap 14.

In contrast to previous coalescing filter cartridges that employ metal end caps, the upper and lower end caps are formed of 15% glass-filled nylon 6 (e.g. Nearshore (15% Glass Fiber) nylon 201272 which is recycled and is available from Oceanworks, 11828 La Grange Ave, Los Angeles, CA, 90025, USA). The upper end cap 10 has a central aperture 16 through which air can enter the cartridge, and is formed with, in this instance, four lugs 18 for bayonet-type connection into slots 42 in a top rim 36 of the filter cage 28. It will be seen that each lug has a tapered leading edge 20 for facilitating insertion into one of the slots, a constant depth central region 22 for resting in the slot and a downwardly projecting tab 24 at its trailing end for abutment with an adjacent region of the housing to define a fully inserted rotational position.

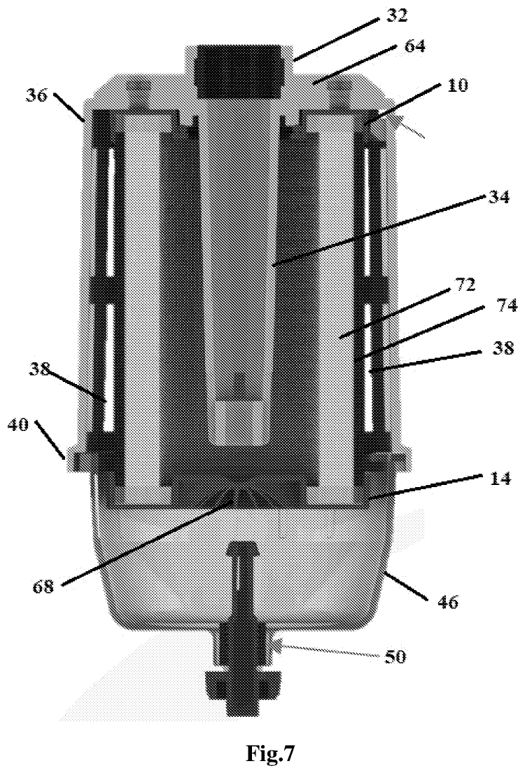

The cylindrical coalescing filter medium 12 is attached at its upper end to end cap 10 and at its lower end to end cap 14 which is also of 15% glass-filled nylon 6 and which has a raised central region 26 that fits within and closes the central region of the medium 12. As seen in FIG. 7, the filter medium 12 comprises an inner filter element 72 where coalescence takes place and a surrounding drainage layer 74.

The filter element 72 may be made as described in EP-B-1979067 (Waltl et al.), the disclosure of which is incorporated herein by reference. The disclosed method comprises (a) forming an aqueous dispersion comprising fibers, wherein said fibers consist of glass micro-fibers (e.g. borosilicate glass microfibres), said dispersion further comprising a thermally curable water-soluble acid-based resin binder comprising a carboxylated acrylic polymer and a polyfunctional alcohol, the dispersion having a pH of about 3; (b) forming a tubular article from the aqueous dispersion by feeding said dispersion to a tubular molding space; and (c) heating the article to successively drive off water and cure the resin.

A preferred resin is Acrodur 950 L (BASF) which has a pH of 3.5, a molecular weight of about 80,000 and a Brookfield viscosity at 23° C. of 600-4000 mPas. It has been stated to crosslink at temperatures as low as 180° C., with a recommended temperature of 200° C. and is an aqueous solution of a substituted polycarboxylic acid containing a polybasic alcohol as the crosslinking agent. The polycarboxylic acid is a carboxylated acrylic polymer and the polybasic alcohol is triethanolamine. The preparation is presented as a 50% solids solution in water with viscosity of 1000-4500 cps, specific gravity of 1.2. It may be used in the dispersion at e.g. a concentration of about 40-80 g/liter depending on the desired mechanical properties of the filter, the effect of resin concentration in the dispersion on pressure drop of the resulting filter medium being relatively small.

The aqueous dispersion may be fed under pressure to the moulding space, and formation of a tubular article may typically comprise introducing the dispersion under pressure into the top of an annular molding space defined between a central core, a vertical cylindrical screen spaced from and outward of said core and a support defining a lower boundary for the molding space so that a mass of fibers becomes compacted on the screen and liquid is discharged from the molding space through the screen; progressively increasing the height of the effective open area of the cylindrical screen by moving upwardly a sleeve in sliding contact with the cylindrical screen at a rate substantially equal to the rate at which the height of the mass of fibers increases above the support; and removing the resulting tubular mass of fibers from the molding space.

The drainage layer 74 may be a butt-welded tubular structure e.g. of non-woven polyester fibres with ends of the drainage layer welded together without overlap so that there is no “dead area” on the filter surface, see WO 2008/1146045 (Spence). The layer may be coated with a fluorocarbon.

The filter housing includes a cage 28 having a top face 30 formed with a central aperture 32 provided with a connector e.g. a, internally threaded brass insert for attachment to an airline or other source of the compressed air stream to be treated. The top face 30 carries a depending inlet tube 34 which in use extends for most of the depth of the filter medium 12 for leading air to lower regions of the cartridge. The inlet tube 34 is open at its lower end and may also have side apertures. A generally cylindrical side wall has a top rim 36 adjacent the top face 30 and a multiplicity of depending ribs with apertures 38 defined between them for discharge of air from the filter and leading to a lower rim 40 formed with circumferentially directed slot 44 for attachment of the filter bowl as described below.

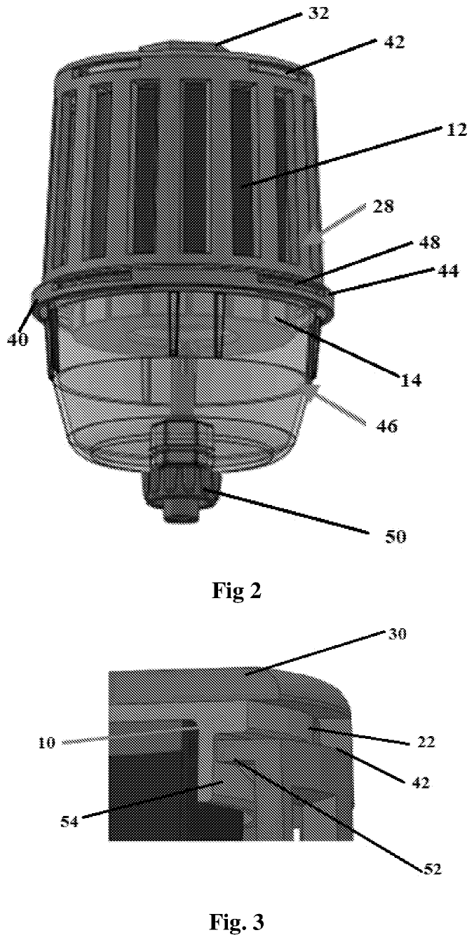

FIG. 2 is a side view of an embodiment of the filter silencer showing the filter medium 12 fitted within the cage 28 with the lugs fitted within and visible through the slots 42 and with the lower end cap 14 slightly below the lower rim 40 of the cage. Transparent polypropylene bowl 46 for prevention of air discharge from the housing except through the apertures 48 and for collection of coalesced oil is shown attached to lower rim 40 and has at its lower end a removable polypropylene plug 50 to permit drainage of oil from the bowl.

FIG. 3 is a fragmentary sectional view of the filter silencer adjacent the rim, showing a lug 22 of top cap 10 engaged in slot 42. It will be seen that the slot has a short inwards extension 52 for additional support of the lug 22, and that the filter top cap has a short depending wall 54 which locates against the inner end of each of the extensions 52 for locating and centering the cartridge relative to the housing.

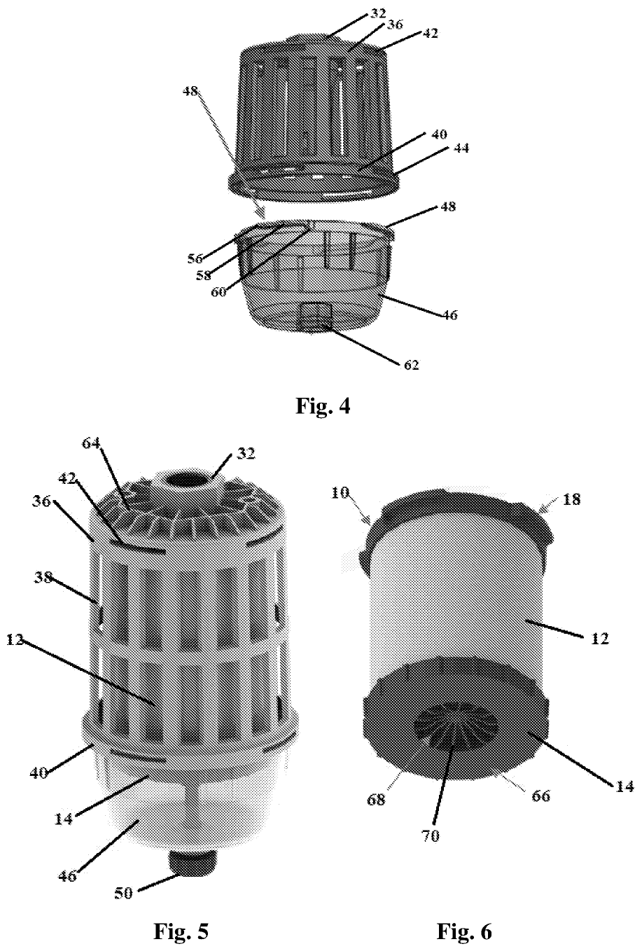

In FIG. 4, the bowl 46 is shown beneath the cage, and it can be seen that the rim of the bowl has four lugs 48 each having a tapered leading edge 56 for facilitating insertion into one of the slots 44, a constant depth central region 58 for resting in the slot and a downwardly projecting tab 60 at its trailing end for abutment with an adjacent region of the housing to define a fully inserted rotational position. In this way, the bowl 46 can be fastened to and removed from the cage by quarter-turn movements in the same way as the filter medium 12. The bowl has an aperture 62 at its lower end for attachment of the polypropylene plug 50.

FIG. 5 shows a prototype of the filter silencer which is similar to what is shown in the earlier figures except that the top face of the cage carries on its outer surface a multiplicity of reinforcing ribs to assist the nylon of the top face resisting the internal pressure of the compressed air when the filter silencer is in use. FIG. 6 shows a prototype of the filter medium 12 and the underside of the lower end cap 14 has a central raised region 68 provided with a multiplicity of radially directed reinforcing ribs 70 to assist the nylon in this region of the lower end cap in withstanding the internal pressure of the compressed air. The raised region 68 and reinforcing ribs also appear in the sectional view of FIG. 7.

1.-15. (canceled)

16. A filter silencer for a compressed air stream that may be contaminated by atomised oil aerosol, comprising:
a cartridge comprising upper and lower end caps of glass-filled nylon and a tubular coalescing filter extending between and adhered to the end caps,
the filter comprising a filter element of resin-bonded glass fibres for coalescing oil in the compressed air stream and a drainage layer for collecting coalesced oil and allowing it to flow through or past the lower end cap,
wherein a rim of the upper end cap is formed with radially outward projecting lugs that in use rotationally fit into circumferentially directed slots within a filter housing immediately below an upper end thereof for retaining the cartridge in the housing with its upper end below the upper end of the housing; and
a cage into which the cartridge can be removably fitted and a bowl that can be removably attached to a lower end of the cage for collecting oil coalesced by the cartridge, the cage a having a roof and a depending wall with an annular top rim and apertures beneath the rim for discharge of air that has passed through the cartridge, the roof being formed with a central aperture and provided with a connector for receiving the compressed air stream and passing it through the central aperture to an inlet tube on its inner face for leading the compressed air stream into the cartridge and towards its lower end, and the top rim being formed with circumferentially directed slots for slidable insertion and removal of the lugs of the end cap on rotation of the cartridge relative to the end cap

17. The filter silencer of claim 16, wherein each lug has a tapered leading edge for facilitating insertion into a slot and a downwardly projecting tab at its trailing end for abutment with an adjacent region of the housing to define a fully inserted rotational position.

18. The filter silencer of claim 16 which has four symmetrically spaced lugs that permit insertion and removal of the cartridge by a quarter turn.

19. The filter silencer of claim 16, wherein the upper end cap has a central aperture configured to receive and fit gas-tightly around an air flow tube depending from the upper end of the housing.

20. The filter silencer of claim 16, wherein the end caps are of 15% glass-filled nylon 6.

21. The filter silencer of claim 16, wherein the glass fibres of the filter element are bonded by a water-soluble acid-based resin binder comprising a carboxylated acrylic polymer and a polyfunctional alcohol.

22. The filter silencer of claim 21, wherein the drainage layer is of polyester fibres coated with fluorocarbon.

23. The cartridge of claim 16, wherein the slots extend radially through the rim and open to the exterior surface thereof.

24. The filter silencer of claim 23, wherein the upper end of the bowl is formed with projecting lugs for fitting into slots in a lower rim of the depending wall.

25. The filter silencer of claim 16, wherein the cage is of nylon.

26. The filter silencer of claim 25, wherein the bowl is of polypropylene.

27. A filter silencer having a cartridge formed with circumferentially directed outwardly projecting lugs at its upper rim configured for forming a bayonet fit into slots at a top rim of a receiving cage forming part of a housing for the filter.

28. The silencer of claim 27, wherein the housing further comprises a bowl having an upper rim formed with projecting lugs configured for forming a bayonet fit into slots at a bottom rim of the receiving cage.
